(19) United States
(12) Patent Application Publication
(10) Pub. No.: US 2006/0064590 A1
(43) Pub. Date: Mar. 23, 2006

(54) Method, processing devices and system for exchanging cryptography data

(76) Inventors: Gerrit Bleumer, Schildow (DE); Clemens Heinrich, Berlin (DE); Volker Baum, Berlin (DE)

Correspondence Address: SCHIFF HARDIN LLP;Patent Department, 6600 Sears Tower, 233 South Wacker Drive, Chicago, IL, 60606, US

(21) Appl. No.: 11/229,466

(22) Filed: Sep. 16, 2005

(30) Foreign Application Priority Data
Sep. 17, 2004 (DE) 10 2004 045 574.0

(51) Int. Cl. H04L 9/00

(52) U.S. Cl. 713/171

(57) ABSTRACT

In a method for exchange of first cryptography data (such as a cryptographic key or a cryptographic certificate) associated with a first data processing device, the current cryptography data are stored in a memory of the first data processing device, with which a current expiration criterion is associated. The stored cryptography data are exchanged for new cryptography data in an exchange step; wherein a communication with a remote second data processing device ensues and the exchange step is implemented at the latest upon fulfillment of the current exchange criterion. The fulfillment of the exchange criterion associated with the current cryptography data and/or the data processing device is monitored in a second data processing device and the second data processing device initiates the exchange step upon fulfillment of the exchange criterion.

### BACKGROUND OF THE INVENTION

1. Field of the Invention

The present invention concerns a method for exchange of cryptography data associated with a first data processing device, in particular a cryptographic key or a cryptographic certificate, of the type wherein current cryptography data (associated with current expiration criterion) stored in a memory of the first data processing device are exchanged with new cryptography data in an exchange step. A communication with a remote second data processing device ensues in the exchange step. The exchange step is implemented, at the latest, after fulfillment of the current expiration criterion. The present invention furthermore concerns an arrangement that is suitable for implementation of such a method.

2. Description of the Prior Art

Cryptography data such as cryptographic keys or cryptographic certificates serve to safeguard or authenticate data in a number of applications in connection with corresponding cryptographic algorithms. Cryptographic keys are used together with corresponding encryption algorithms in order to encrypt data and to protect it from unauthorized access. They can likewise be used in order to sign data and thus to make their origin and authenticity traceable.

The basis for all of these security measures is that at least one part of the cryptographic keys that are used is kept secret, i.e. is only known to a very narrowly limited user circle, often only to a single user. If this secrecy is penetrated, for example a secret key is compromised, the security is no longer ensured. Depending on the level the compromised key has in a cryptographic hierarchy, eventually the security of one or more dependent key levels and a number of cryptographic keys can be lost.

The typically-used cryptographic methods all exhibit the disadvantage that, although an extremely large computational effort must be undertaken in order to determine a secret key using only the encrypted data generated with it, with increasing duration of use or increasing scope of use of the secret key, the probability increases that the key will be compromised in this manner. In other words, the security system steadily becomes less secure with increasing use or usage duration of a specific key.

In order to remedy this disadvantage, it is typical, from time to time, to exchange the cryptography data used by a data processing device (such as cryptographic keys or cryptographic certificates) for new cryptography data in order to maintain a certain security level. For this purpose, a temporal or non-temporal expiration criterion typically is associated with the cryptography data as an exchange criterion; the exchange of the cryptography data ensuing upon fulfillment of this exchange criterion.

It is known from U.S. Pat. No. 6,041,317 to always exchange a key pair of a security module of a franking machine when a specific expiration criterion has been fulfilled, for example a specific number of cryptographic operations have been conducted with the key pair of the security module. For this purpose, the security module monitors the expiration criterion. When the expiration criterion is fulfilled, the security module generates a new key pair and exchanges the previous key pair in a communication with a remote data center.

This method does in fact reliably deliver new cryptography data at intervals that are acceptable under security aspects, but it has the disadvantage that a complicated monitoring routine that monitors the expiration criterion must be implemented in the security module. Moreover, no monitoring is possible of exchange criteria that are not inherent in or known to the security module that also make an exchange of cryptography data necessary.

### SUMMARY OF THE INVENTION

An object of the present invention is to provide a method and an arrangement of the previously-cited type that do not exhibit the aforementioned disadvantages, or at least exhibit them to a lesser degree, and that in particular enable a simple monitoring of arbitrarily predeterminable exchange criteria.

The above object is achieved in accordance with the present invention by a method of the type initially described wherein the fulfillment of the exchange criterion associated with the cryptography data currently in use and/or the first data processing device is monitored in the second data processing device and the second data processing device initiates the exchange step upon fulfillment of the exchange criterion.

The monitoring of the exchange criterion in the second data processing device makes the elaborate implementation of corresponding monitoring mechanisms in the first data processing device unnecessary. Furthermore, any exchange criteria that are not inherent in or known to the first data processing device, or that cannot be calculated by it, can also be taken into account as part of the exchange criterion (or criteria).

For example, an arbitrarily predeterminable datum or the like can be selected as an exchange criterion. If this exchange criterion is then set for all or individual first data processing devices, the exchange of the first cryptography data is initiated as soon as the set datum has been achieved—thus the exchange criterion is fulfilled—and one of the first data processing devices contacts the second data processing device. This contact can ensue, for example, in the framework of communication of the first data processing device with the second data processing device that, was initiated by the first data processing device for a different purpose than the exchange of the cryptography data—for example for downloading of postage into a franking machine (as the first data processing device).

The exchange criterion can be predetermined by either processing device, but preferably the first exchange criterion is predetermined by the second data processing device.

The exchange criterion in principle can have an arbitrary relationship with the current expiration criterion that is associated with the current cryptography data (i.e. the cryptography data currently in use before the exchange). The exchange criterion can be selected to be the same as the current expiration criterion, such that the exchange of the cryptography data ensues at the earliest when the expiration criterion is fulfilled (the current cryptography data are no longer valid). In order to prevent situations in which security operations conducted using the current cryptography data are temporarily no longer available due to their invalidity, the exchange criterion preferably is selected so that the fulfillment thereof occurs temporally prior to the fulfillment of the expiration criterion.

The time span between the occurrence of the exchange criterion and the occurrence of the expiration criterion is, if possible, selected so that at least one communication normally arise occur between the first data processing device and the second data processing device in this time span. It is thus ensured that, in the normal case, an exchange of the cryptography data can ensue before the expiration criterion occurs.

As mentioned, both the expiration criterion and the exchange criterion can be arbitrary criteria. The expiration criterion and/or the exchange criterion can be a non-temporal criterion. One or both can be a criterion dependent on the usage of the first data processing device. For example, reaching a specific number of cryptographic operations using the current cryptography data can be used as the criterion. The criterion can likewise be dependent on the current cryptography data, for example on the scope of the current cryptography data (for example the key length of cryptographic keys).

In preferred versions of the inventive method, a new validity criterion is associated with the new cryptography data, the fulfillment of the new validity criterion defining the beginning of the validity of the new cryptography data. The new validity criterion is selected such that fulfillment thereof occurs at the latest with the fulfillment of the current expiration criterion. A seamless transfer between the validity of the current cryptography data and the validity of the new cryptography data thus can be achieved.

The current first cryptography data may still be used up to the fulfillment of the current expiration criterion while the new cryptography data is loaded into the memory of the first data processing device, even though the new cryptography data are not yet valid.

In a further embodiment of the invention, the new validity criterion can be selected so that fulfillment thereof occurs before the fulfillment of the current expiration criterion. In a simple manner, this enables constellations in which both the current cryptography data and the new cryptography data can be valid for an overlapping time span and can be optionally used in parallel.

This is of particular advantage when the cryptography data that are the subject of the exchange are not in the lowest level of a cryptographic hierarchy, but rather other cryptography data exist that are dependent thereon. The current cryptography data and the new cryptography data then can be used in parallel until the cryptographic linking of the dependent data has been transferred to the new cryptography data, for example likewise by exchange of the dependent levels of cryptography data.

Preferably, the new cryptography data and the current cryptography data are both stored in the aforementioned memory at least until fulfillment of the current expiration criterion. It will be understood that a number of generations of cryptography data, possibly even all generations of the cryptography data, can remain stored in parallel in the memory.

The exchange criterion can be predetermined once or can be unchanged for a longer time span. For example, a usage-dependent exchange criterion can remain unchanged over a number of exchange steps. Preferably, however, the exchange criterion is modified upon conclusion of the exchange step.

The exchange of the cryptography data described above can be effected at any points or hierarchy levels within a cryptographic hierarchy. In other words, the cryptography data of an arbitrary nature or type can be exchanged within a cryptographic hierarchy according to the described method. If cryptography data of a type that are not in on the lowermost hierarchy level are exchanged, this normally also requires an exchange of the cryptography data in the subordinate levels in order to migrate (transfer) the cryptographic link between the levels to the new generation of cryptography data.

In preferred versions of the inventive method the previously discussed cryptography data are first cryptography data and, for exchange of second cryptography data (in particular a second cryptographic key or a second cryptographic certificate) associated with the second data processing device, current second cryptography data stored in a memory of the second data processing device with a second exchange criterion being associated with the second cryptography data are exchanged for new second cryptography data in a second exchange step. Furthermore, the second exchange step is implemented at the latest upon fulfillment of the second exchange criterion.

The second exchange step can be resolved and implemented alone in the second data processing device when it is at a correspondingly high position in a cryptographic hierarchy. In other variants, the exchange of the second cryptography data preferably ensues with the participation of a third data processing device that is preferably superordinate in the cryptographic hierarchy.

In preferred variants of the inventive method, a communication with such a remote third data processing device ensues in the second exchange step. The fulfillment of the second exchange criterion associated with the current second cryptography data and/or the second data processing device is then monitored in the third data processing device, and the third data processing device then initiates the second exchange step upon fulfillment of the second exchange criterion.

In a manner analogous to the embodiments above, the second exchange criterion also can be predetermined by the third data processing device. Furthermore, in a similar manner the fulfillment of the second exchange criterion here can be selected so as to occur before the fulfillment of the current second expiration criterion.

The second expiration criterion and/or the second exchange criterion also can be an arbitrary temporal or non-temporal criterion, for example a criterion dependent on the usage of the second data processing device. This criterion can likewise be a criterion dependent on the current second cryptographic data, for example dependent on the scope of the current second cryptography data (for example the key length of cryptographic keys).

A new second validity criterion also can be associated with the new second cryptography data, the fulfillment of the new second validity criterion defining the beginning of the validity of the new second cryptography data. The embodiments above with regard to the first cryptography data are applicable here as well. This is likewise true for the variants in which the fulfillment of the new second validity criterion occurs at the latest with the fulfillment of the current second expiration criterion, in particular before the fulfillment of the current second expiration criterion.

In variants of the inventive method, the new second cryptography data and the current second cryptography data are both stored in the memory of the second data processing device at least until fulfillment of the current second expiration criterion. It is thus possible to use the new second cryptography data and the current second cryptography data in parallel. This is notably advantageous when a cryptographic dependency of the first cryptography data on the second cryptography data exists. In this case, the current second cryptography data still can be used until the first cryptography data are likewise exchanged. It is thus achieved that a valid cryptographic link always exists between the first data processing device and the second data processing device.

Preferably, the first exchange criterion is selected so as to be dependent on the new second validity criterion. The exchange of the first cryptography data thus can be simply coupled to the exchange of the second cryptography data. The first exchange criterion preferably is selected the same as the new second validity criterion. In other words, the exchange of the first cryptography data is ready up as soon as the new second cryptography data become valid. For example, this can be a purely temporal procedure when the new second validity criterion is the reaching of a validity point in time of the new second cryptography data.

The first exchange criterion can be individually specified for each first data processing device of a multiple device system. In a preferred variant of the inventive method, however, a common first exchange criterion is predetermined for a number of first data processing devices. For example, in the case of an actual or suspected compromise of cryptography data that are superordinate to the first cryptography data of a number of first data processing devices in a cryptographic hierarchy, a common first exchange criterion that forces the immediate exchange of the first cryptography data upon next communication with the second data processing device is predetermined for these first data processing devices.

The exchange of the cryptography data can ensue in an arbitrary suitable manner. Predetermined new cryptography data can be simply loaded into the respective data processing device. It is likewise possible for the new cryptography data to be ab initio in the framework of the exchange. Arbitrary methods or algorithms for generation of the new cryptography data can be applied. The generation of the new cryptography data can ensue both in the first data processing device and in the second data processing device.

It is particularly advantageous to use methods that are dependent on the fulfillment of at least one temporal or non-temporal generation criterion. For example, with a temporal generation criterion the generated new cryptography data can have a size that is increased by a specific amount at specific points in time. In the case of cryptographic keys, this can mean that the newly-generated key exhibits a length increased by N bits at specific points in time, for example yearly. The generation algorithm of the new cryptography data likewise can be changed or modified at specific times, for example monthly. Moreover, a number of different generation algorithms for the new cryptography data can be used at specific times in a specific manner, for example in parallel or alternating.

For example, with a non-temporal generation criterion the generation algorithm of the new cryptography data can be selected dependent on the extent of the usage of the current cryptography data. For example, new cryptography data with increased size can be generated given extensive usage of the current cryptography data above a specific usage threshold. In the case of cryptographic keys, this can mean that, given a usage of the current key over a specific time, the length of the newly-generated key will be increased by N bits compared to the current in order to reduce the risk of being compromised.

Further non-temporal generation criteria can likewise be used. For example, an arbitrary non-temporal generation criterion can be predetermined by the second or third data processing device.

The present invention furthermore concerns an arrangement for exchange of cryptography data associated with a first data processing device (in particular a cryptographic key or a cryptographic certificate) wherein a second data processing device, remote from the first data processing device, can be placed in communication with the first data processing device via a communication network. The first data processing device has a memory in which the current cryptography data are stored, the current cryptography data having an expiration criterion associated therewith. The first data processing device and the second data processing device are fashioned for exchange of the current cryptography data in the memory for new cryptography data in a communication between the devices, at the latest upon fulfillment of the current expiration criterion. According to the invention, the second data processing device monitors the fulfillment of the exchange criterion associated with the current cryptography data and/or the first data processing device. Furthermore, the second data processing device initiates the exchange of the current cryptography data upon fulfillment of the exchange criterion.

This arrangement is suitable for implementation of the inventive method described above. Furthermore, the variants and advantages of the inventive method that are described above can be realized by the arrangement to an equal degree, so that reference is made in this regard to the above method embodiments.

The second data processing device preferably provides the exchange criterion. Furthermore, it is preferably fashioned for specification of a new validity criterion described above for the new cryptography data. Furthermore, it is preferably fashioned for modifications (described above) of the exchange criterion upon conclusion of the exchange of the cryptography data.

The first data processing device preferably stores both the new cryptography data and the current cryptography data, at least until fulfillment of the current expiration criterion in the memory.

In preferred variants of the inventive arrangement, a third data processing device is provided for exchange of second cryptography data (in particular a second cryptographic key or a second cryptographic certificate) associated with the second data processing device. The second data processing device then has a memory in which the current second cryptography data are stored, with a current second expiration criterion associated therewith. Furthermore, the second data processing device and the third data processing device are fashioned for exchange of the current second cryptography data in the memory of the second device for new second cryptography data in a communication between the second and third devices, at the latest upon fulfillment of the previous second expiration criterion.

The third data processing device is preferably monitors (as described above) the fulfillment of the second exchange criterion associated with the current second cryptography data and/or the second data processing device. Furthermore, the third device initiates the exchange of the current second cryptography data upon fulfillment of the second exchange criterion. The third data processing device preferably specifies the second exchange criterion.

In preferred variants of the inventive arrangement, the second data processing device stores therein both the new second cryptography data and the current second cryptography data, at least until fulfillment of the current second expiration criterion. Parallel use (described above) of the old and new second cryptography data thus is possible for a specific span of time.

In preferred variants of the inventive arrangement, the third data processing device specifies the first exchange criterion dependent on the new second validity criterion in order to initiate the exchange as described above in a timely manner.

In further preferred variants of the inventive arrangement, a first number of first data processing devices are provided that can be connected with the second data processing device, and the second data processing device is fashioned for specification of a common first exchange criterion for a second number of first data processing devices. The selective exchange (described above) of the cryptography data can be simultaneously predetermined, or initiated for a series of first data processing devices.

The present invention can be used in connection with arbitrary data processing devices for any application in which cryptography data are used and must accordingly be exchanged from time to time. Use in the field of franking machines is particularly advantageous, since this involves particularly high security requirements due to the monetary transactions in the franking machine. The first data processing device therefore is preferably a franking machine. Additionally or alternatively, the second data processing device preferably is a remote data center.

The present invention furthermore concerns a data processing device that is fashioned to function as the second data processing device described above, including all of the variants and advantages described above in connection with the second data processing device.

The present invention furthermore concerns a data processing device is fashioned to function as a third data processing device described above, including all of the variants and advantages described above in connection with the third data processing device.

### DESCRIPTION OF THE DRAWINGS

FIG. 1 schematically illustrates a preferred embodiment of the inventive arrangement for implementation of a preferred embodiment of the inventive method for exchange of cryptography data associated with a data processing device.

FIG. 2 is a flow chart of a preferred embodiment of the inventive method for exchange of cryptography data associated with a data processing device, the method being implemented with the arrangement of FIG. 1.

FIG. 3 is a time diagram of the use of individual generations of the cryptography data in the arrangement of FIG. 1.

FIG. 4 is a flow chart of a preferred embodiment of the inventive method for exchange of second cryptography data associated with a second data processing device, the method being implemented with the arrangement from FIG. 1.

FIG. 5 is a time diagram of the use of individual generations of the second cryptography data in the arrangement of FIG. 1.

FIG. 6 is a time diagram of the use of individual generations of the cryptography data for a further preferred variant of the arrangement of FIG. 1.

### DESCRIPTION OF THE PREFERRED EMBODIMENTS

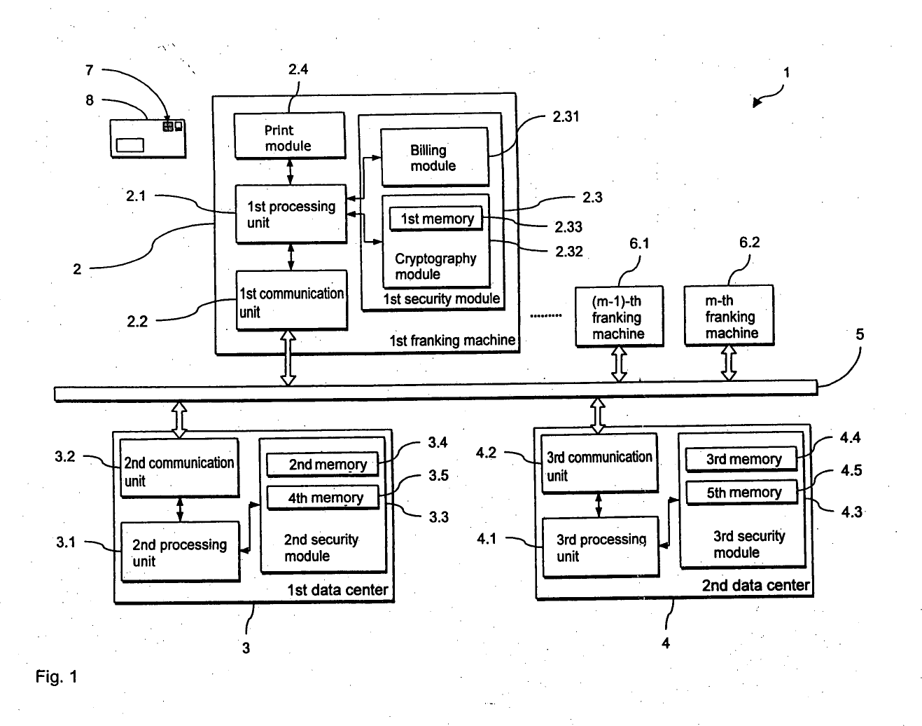

FIG. 1 schematically illustrates a preferred embodiment of an inventive arrangement 1 for implementation of a preferred embodiment of the inventive method for exchange of cryptography data associated with a data processing device.

The arrangement includes a first data processing device in the form of a first franking machine 2, a second data processing device in the form of a first data center 3 of the manufacturer of the franking machine 2, and a third data processing device in the form of a second data center 4 of a cryptographic certification entity, all of which can be connected with a communication network 5. Further franking machines 6.1, 6.2 that are identical to the franking machine 2 in design and function can likewise be connected with the communication network 5. In total, m franking machines are provided in the present example.

The franking machine 2 has a first processing unit 2.1 and a first communication unit 2.2 connected therewith in the form of a modem. Furthermore, the franking machine 2 has a first security module 2.3 connected with the first processing unit 2.1. Finally, the franking machine 2 has a printing device in the form of a first printing module 2.4 that is connected with the first processing unit 2.1 and that is activated thereby.

The first security module 2.3 includes a billing module 2.31 and a cryptography module 2.32. The billing module 2.31 thereby serves for billing franking imprints 7 that are printed by the printing module 2.4 on mail pieces 8. As soon as the data necessary for the respective franking imprint 7 have been generated, billing for this ensues in the billing module 2.31. In addition, registers contained in the billing module 2.31 are increased (known as the ascending register) or decreased (known as the descending register) in a known manner by values that correspond to the printed postage value of the franking imprint 7.

In order to secure the franking imprint 7 against counterfeits, at least one item of security information (for example a cryptonumber or the like) is integrated into the franking imprint 7. Using a cryptographic algorithm stored in the first memory 2.33, this security information is generated in the cryptography module 2.32 from postal information that are associated with the respective mail piece 8. To generate the security information, among other things the cryptography module 2.32 accesses the first cryptography data stored in the first memory 2.33 in the form of a first cryptographic key K1.

The first data center 3 (which, in the present example, is operated by the manufacturer of the franking machine 2) has a second processing unit 3.1 and a second communication unit 3.2 connected therewith in the form of a modem bank. Furthermore, the data center 3 has a second security module 3.3 connected with the second processing unit 3.1, the second security module 3.3 including a second memory 3.4 and a third memory 3.5.

Via the communication network 5, the franking machine 2 can request or invoke specific services from the first data center 3 such as, for example, the downloading of postage, etc. For this purpose, it establishes a communication channel with the first data center 3 via its first communication unit 2.2, the communication network 5 and the second communication unit 3.2 of the data center 3. As is explained in further detail in the following, in the framework of such a communication the exchange of the current first cryptography data stored in the first memory 2.33 is initiated from time to time. As has been explained, this exchange occurs for the purpose of reducing the probability of a compromising of the security measures implemented using the first cryptography data.

The first cryptography data of the franking machines 2, 6.1 and 6.2 are embedded in a cryptographic hierarchy. A cryptographic link exists with regard to superordinate second cryptography data of the first data center 3. These second cryptography data, for example a second cryptographic key K2, are stored in the second memory 3.4 of the second security module 3.3 of the first data center 3. The cryptographic link is generated in a known manner in that the first data center 3 generates a first cryptographic certificate KC1 over the first cryptography key K1 using the cryptographic key K2. It is then stored, among other things, in the first memory 2.33.

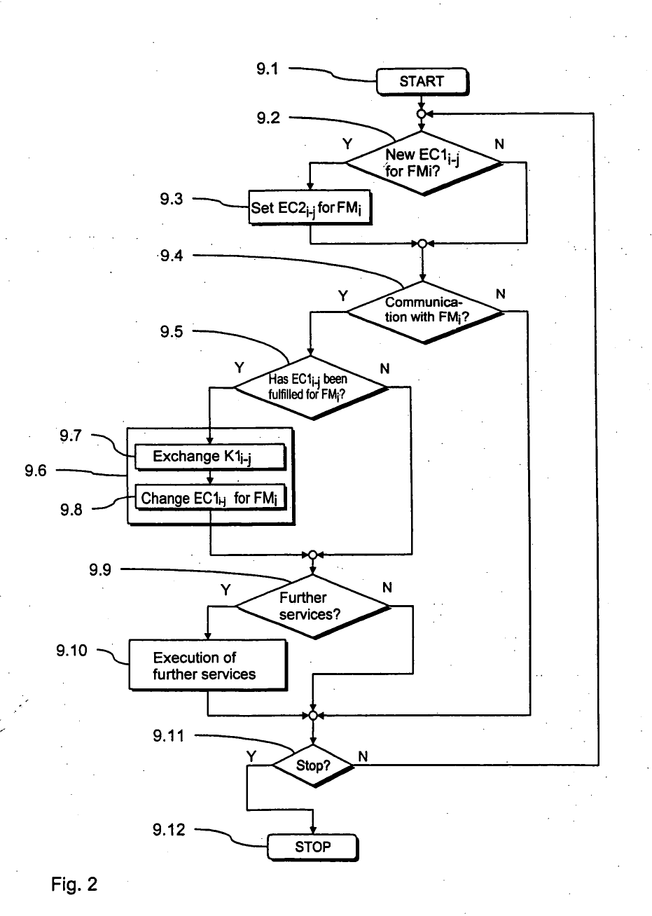

In the following, the process of a preferred embodiment of the inventive method for exchange of the first cryptography data associated with the first data processing devices 2, 6.1, 6.2 is described with reference to FIGS. 1 through 3.

The method is started in a step 9.1. In a step 9.2, the second processing unit 3.1 checks whether a new first exchange criterion EC1ᵢ₋ⱼ is to be provided for a franking machine FMᵢ (with i=1 . . . m) of the m franking machines 2 through 6.2.

This first exchange criterion EC1ᵢ₋ⱼ monitored by the first data center 3 determines whether and when the first cryptography data (thus the first key K1ᵢ₋ⱼ) of the appertaining franking machine FMᵢ is to be exchanged. The first exchange criterion can be an arbitrary criterion predeterminable by the first data center 3. For example, it can be a purely temporal criterion that provides a point in time T_{EC11-j} at which the first cryptography data K1ᵢ₋ⱼ of the j-th generation of the appertaining i-th franking machine FMᵢ are to be exchanged. It can likewise be a usage-dependent criterion the fulfillment of which causes the exchange of the first cryptography data to ensue.

Furthermore, the first exchange criterion ECᵢ₋ⱼ can be a combined criterion, for example a combined temporal and usage-dependent criterion. It can thus establish that the exchange ensues after reaching a specific usage scope, however at the latest after a specific predetermined exchange point in time. This exchange point in time, for example, can be selected dependent on the end point in time of the validity term T_{VE1i-j} predetermined for the current first cryptography data K1ᵢ₋ⱼ currently present in the first memory 2.33. It can in particular be the same as this point in time.

If a new first exchange criterion EC1ᵢ₋ⱼ should be provided for the i-th franking machine FMᵢ, this ensues in a step 9.3 via the second security module 3.3, which stores the new first exchange criterion EC1ᵢ₋ⱼ in the fourth memory 3.5. It is understood that, in other variants of the invention, the new first exchange criterion EC1ᵢ₋ⱼ can be predetermined by any suitable instance other than the first data center 3.

In a step 9.4, it is then checked whether a communication connection with any franking machine FMᵢ exists via the communication network 5. If this is not the case, at this point the method jumps back to step 9.2 in the event that the method should not be ended.

However, if a communication connection with the i-th franking machine FMᵢ exists, by access to the second memory 3.4 the second processing unit 3.1 checks in a step 9.5 whether the first exchange criterion EC1ᵢ₋ⱼ has been fulfilled for this franking machine FMᵢ for the current generation j of the current first cryptography data K1ᵢ₋ⱼ present in the first memory 2.33.

If this is the case, the first data center 3 initiates a first exchange step 9.6. In this step 9.6, the exchange of the current first cryptography data K1ᵢ₋ⱼ of the j-th generation present in the first memory of the franking machine FMᵢ initially ensues in a step 9.7. The data K1ᵢ₋ⱼ are replaced by new first cryptography data K1ᵢ₋₍ⱼ₊ᵢ₎ of the (j+1)-th generation. The current first cryptography data K1ᵢ₋ⱼ of the j-th generation present in the first memory 2.33 of the franking machine FMᵢ are overwritten with the new first cryptography data K1ᵢ₍ⱼ₊ᵢ) of the (j+1)-th generation so that the new data are then used by the franking machine FMᵢ from the point in time of the replacement onward. It is understood that, in other variants of the invention, the individual generations of the first cryptography data are also stored in parallel in the first memory 2.33, at least for a specific time. For example, the old first cryptography data can remain stored until a predetermined first expiration criterion for them has been fulfilled; in other words, until the end of their validity period has been reached. Only the newest generation of the first cryptography data, however, is then activated by suitable means.

The exchange of the current first cryptography data K1ᵢ₋ⱼ of the j-th generation for the new first cryptography data K1ᵢ₋₍ⱼ₊₁₎ of the (j+1)-th generation can ensue in any suitable manner. The new first cryptography data K1ᵢ₋₍ⱼ₊₁₎ can thus simply be provided by the first data center 3. This can be the case, for example, when an externally-provided secret key is to be exchanged in the franking machine FMᵢ.

However, if an asymmetrical key pair is exchanged, for example, this can initially be generated by the franking machine; the public key can then be cryptographically certified by the first data center and the asymmetrical key pair can then be stored in the first storage together with the valid cryptographic certificate obtained from the first data center 3. The cryptographic certificate thereby represents the cryptographic link between the asymmetrical key pair (thus the first cryptography data) and the second cryptography data of the first data center 3, using which second cryptography data the cryptographic certificate was created. Furthermore, it is understood that any other suitable exchange method or processes can be used.

In both cases, a usage-dependent (i.e. non-temporal) generation criterion can be predetermined for the exchange. If the usage of the previous first cryptography data K1ᵢ₋ⱼ of the j-th generation exceeds a specific first usage threshold, new first cryptography data K1ᵢ₋₍ⱼ₊ᵢ₎ of the (j+1)-th generation can be generated with a size that is increased relative to the previous first cryptography data K1ᵢ₋ⱼ of the j-th generation. With cryptographic keys, this can be an increased key length. Naturally, a relative reduction of the size of new first cryptography data K1ᵢ₋₍ⱼ₊ᵢ₎ of the (j+1)-th generation can likewise be provided when the usage of the previous first cryptography data K1ᵢ₋ⱼ of the j-th generation falls short of a specific second usage threshold. Furthermore, a number of usage thresholds with associated different sizes of the new first cryptography data K1ᵢ₋₍ⱼ₊ᵢ₎ of the (j+1)-th generation can be provided. Additionally or alternatively, the use of different generation algorithms for the new first cryptography data K1ᵢ₋₍ⱼ₊ᵢ₎ of the (j+1)-th generation can be associated with the exceeding of or failure to reach the respective usage threshold. The generation of the new first cryptography data can ensue both in the franking machine 2 and in the first data center 3.

After a successful exchange of the first cryptography data in the step 9.7, in a step 9.8 the present first exchange criterion EC1ᵢ₋ⱼ of the j-th generation stored in the fourth memory 3.5 is then changed in the first data center 3. For this, a new first exchange criterion of the (j+1)-th generation is immediately provided. Alternatively, initially no valid first exchange criterion is provided and this is set again only at a later point in time, for example in step 9.2. In this case, it is predetermined that initially no exchange of the first cryptography data is to take place for the appertaining franking machine. The appertaining franking machine is, in other words, then initially marked as not being designated for an exchange of the first cryptography data.

In other variants of the invention, this change of the first exchange criterion can be omitted. This can be the case when the first exchange criterion is a usage-dependent criterion or the passage of a specific time interval since the last exchange. Such a first exchange criterion can possibly be left unchanged.

If the change of the first exchange criterion has ensued, in a step 9.9 the second processing unit 3.1 checks whether further services have been requested by the franking machine FMᵢ. These services can be, for example, the downloading of postage into the billing module 2.31, or any other services.

If further services have been requested by the franking machine FMᵢ, these are executed in a step 9.10 before it is checked in a step 9.11 whether the method should be ended. If this is the case, the method is ended in a step 9.12. Otherwise the method jumps back to step 9.2.

The exchange of the first cryptography data can ensue when this has not been requested by the franking machine, FMᵢ, but when other services are requested in the communication. It is thus possible to centrally control the exchange of the first cryptography data from the first data center 3 without specific initiation thereof by the franking machine FMᵢ.

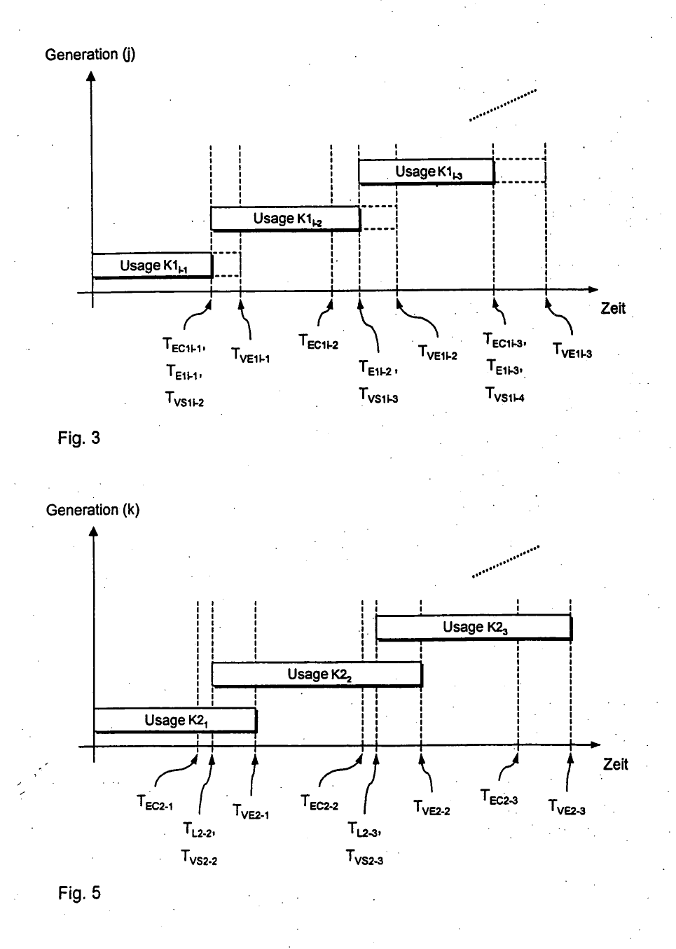

As can be seen from FIG. 3, no temporal overlapping of the usage of the different generations j of the first cryptography data K1ᵢ₋ⱼ of the i-th franking machine FMᵢ ensues in the present example. The first generation of the first cryptography data K1ᵢ₋ⱼ at an exchange point in time T_{E1i-1} are thus exchanged for new first cryptography data K1ᵢ₋₂ of the second generation. The usage of the first generation of the first cryptography data K1ᵢ₋₁ ends at this point in time T_{E1i-1} and the usage of the second generation of the first cryptography data K1ᵢ₋₂ begins. In the present example, the beginning of its validity period T_{VS1i-2} essentially coincides with the exchange point in time T_{Eli-1} in order to create no usage gaps or overlaps.

In this example, the exchange point in time T_{E1i-1} furthermore essentially coincides with the point in time T_{EC1i-1} of the fulfillment of the first exchange criterion EC1ᵢ₋₁. It is important here that the first exchange criterion EC1ᵢ₋₁ of the first generation is a usage-dependent criterion that depends on the usage of the first cryptography data K1ᵢ₋₁ of the first generation. This usage is communicated to the first data center 3 in the framework of the communication with the i-th franking machine. If the first data center 3 establishes that the first exchange criterion EC1ᵢ₋₁ of the first generation has been fulfilled, the exchange of the first cryptographic data ensues immediately.

As can also be seen from FIG. 3, the second generation of the first cryptography data K1ᵢ₋₂ is exchanged for new first cryptography data K1ᵢ₋₃ of the third generation at an exchange point in time T_{E1i-2}. The usage of the second generation of the first cryptography data K1ᵢ₋₂ ends at this point in time T_{E1i-2} and the usage of the third generation of the first cryptography data K1ᵢ₋₃ begins. In the present example, the beginning of its validity period T_{VS1i-3} again essentially coincides with the exchange point in time T_{E1i-2} in order to create no usage gaps or overlaps.

In this example, the exchange point in time T_{E1i-2} of the first cryptography data K1ᵢ₋₂ of the second generation is after the point in time T_{EC1i-2} of the fulfillment of the first exchange criterion EC1ᵢ₋₂ of the second generation. It is important here that the first exchange criterion EC1ᵢ₋₂ of the second generation is a temporal criterion that defines the point in time T_{EC1i-2}. However, the communication with the i-th franking machine (in the framework of which the exchange is initiated) here ensues only after the point in time T_{EC1i-2} of the fulfillment of the first exchange criterion EC1ᵢ₋₂ of the second generation so that the exchange point in time T_{E1i-2} is later than the point in time T_{EC1i-2}.

As is indicated in FIG. 3, the exchange of the first cryptography data K1ᵢ₋ⱼ of further generations correspondingly continues. First exchange criteria of any type can be used.

In all cases, the first exchange criterion EC1ᵢ₋ⱼ preferably is selected so that the fulfillment thereof and the exchange point in time T_{E1i-j} occur, in the normal case, before the fulfillment of a first expiration criterion of the first cryptography data K1ᵢ₋ⱼ associated with the respective generation of the first cryptography data K1ᵢ₋ⱼ. In the present example, this first expiration criterion is fulfilled when the end of the validity period T_{VE1i-j} of the current generation j of the first cryptography data K1ᵢ₋ⱼ is reached. This selection of the first exchange criterion EC1ᵢ₋ⱼ serves to ensure that no usage gaps of the i-th franking machine FMᵢ occur due to the absence of valid first cryptography data.

The first expiration criterion need not be a temporal criterion but rather a usage-dependent criterion that depends on the use of the first cryptography data K1ᵢ₋₁ of the first generation. It can likewise be a combined time-dependent and usage-dependent criterion.

In this context, it is furthermore understood that the first exchange criterion EC1ᵢ₋ⱼ can be collectively provided for a number of franking machines. For example, depending on the model of the franking machine etc., a first exchange criterion can be predetermined for a first group of franking machines that includes all franking machines of a specific model. Naturally other groups of franking machines can likewise be formed according to arbitrary criteria for which a first exchange criterion is collectively provided.

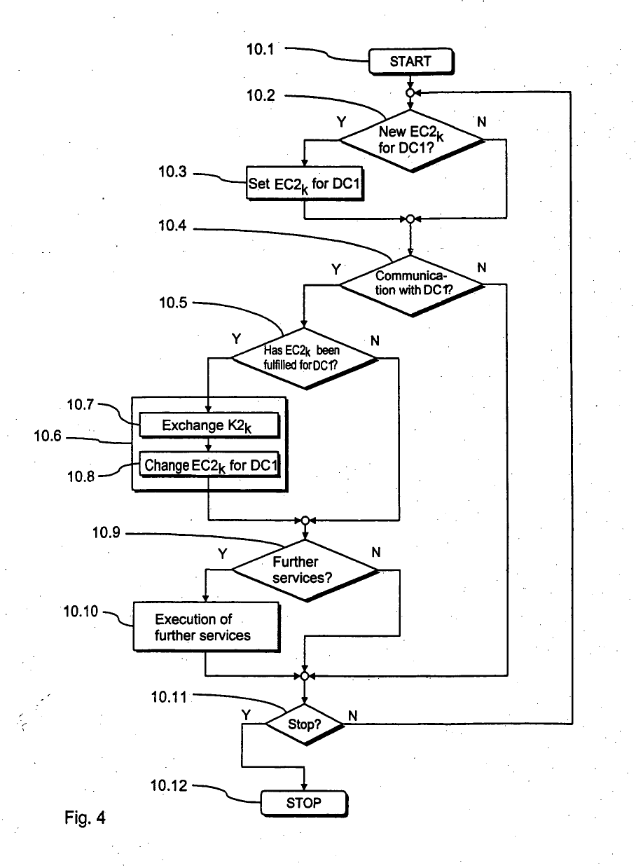

A preferred embodiment of the inventive method for exchange of the second cryptography data of the first data center is described in the following with reference to FIGS. 1, 4 and 5.

The method is started in a step 10.1. In a step 10.2, the third processing unit 4.1 of the second data center 4 checks whether a new second exchange criterion EC2 is to be provided for the first data center (DC1) 3.

This second exchange criterion EC2 monitored by the second data center 4 determines whether and when the second cryptography data K2 (for example a second key) of the first data center 3 is to be exchanged. The second exchange criterion can be an arbitrary criterion predetermined by the second data center 3. For example, it can be a purely temporal criterion that provides a point in time T_{EC1i-j} at which the second cryptography data K2ₖ of the k-th generation of the first data center 3 are to be exchanged. It can likewise be an already-described usage-dependent criterion, the fulfillment of which causes the second cryptography data to ensue.

Furthermore, the second exchange criterion EC2ₖ can likewise be a combined criterion described above. The exchange point in time can in turn be dependent on the end point in time of the validity term T_{VE2k} predetermined for the previous current second cryptography data K2ₖ currently present in the second memory 2.2. In particular it can be the same as this.

If a new second exchange criterion EC2ₖ should be provided for the first data center 3, this ensues in a step 10.3 via the third security module 4.3, which stores the new second exchange criterion EC2ₖ in the fifth memory 4.5. In other variants of the invention, the new second exchange criterion EC1ᵢ₋ⱼ can be predetermined by any suitable entity other than the second data center 4.

In a step 10.4, it is then checked whether a communication connection with the first data center 3 exists over the communication network 5. If this is not the case, at this point the method jumps back to step 10.2 in the event that the method process should not be ended.

However, if a communication connection with the first data center 3 exists, in a step 10.5 it is checked whether the second exchange criterion EC2ₖ has been fulfilled for the first data center 3 for the current generation k of the current second cryptography data K2ₖ present in the first memory 2.33.

If this is the case, the second data center 4 initiates a first exchange step 10.6 wherein, in a step 10.7, new second cryptography data K2₍ₖ₊₁₎ of the (k+1)-th generation are initially loaded in the second memory 3.4 of the first data center 3. These date are then used (in addition to the existing current second cryptography data K2ₖ of the k-th generation) by the data center 3 until the end of the validity period T_{VE2-k} of the current second cryptography data K2ₖ of the k-th generation has been reached. From this end of the validity period T_{VE2-k} onwards, initially only the second cryptography data K2₍ₖ₊₁₎ of the (k+1)-th generation is then used.

The loading of new second cryptography data K2₍ₖ₊₁₎ of the (k+1)-th generation can ensue in any suitable manner. The new second cryptography data K2₍ₖ₊₁₎ thus can simply be provided by the second data center 4. This can be the case, for example, when an externally-provided secret key is to be exchanged in the first data center 3.

However, if an asymmetrical key pair is exchanged, this can initially be generated by the first data center 3; the public key can then be cryptographically certified by the second data center 4 and the asymmetrical key pair then can be stored in the second memory 3.4 together with the valid cryptographic certificate obtained from the second data center 4. The cryptographic certificate represents the cryptographic link between the asymmetrical key pair (thus the second cryptography data) and the third cryptography data of the second data center 4, using which third cryptography data the cryptographic certificate was created. Furthermore, it is understood that any other suitable exchange method can be used.

After a successful loading of the new second cryptography data, in a step 10.8 the present second exchange criterion EC2ₖ of the k-th generation stored in the fourth memory 3.5 is then changed in the first data center 3. For this purpose, a new second exchange criterion of the (k+1)-th generation can be immediately provided. Alternatively, initially no valid second exchange criterion is provided but this is only set again at a later point in time, for example in step 10.2. In this case, it is (in other words) predetermined that initially no exchange of the second cryptography data occurs.

In other variants of the invention, this change of the second exchange criterion can be omitted. This can be the case when the second exchange criterion is a usage-dependent criterion or the passage of a specific time interval since the last exchange.

If the change of the second exchange criterion has ensued, in a step 10.10 the third processing unit 4.1 checks whether further services have been requested by the data center 3. These services can be any services. If further services have been requested by the data center 3, these are executed in a step 10.10 before it is checked in a step 10.11 whether the method should be ended. If this is the case, the method is ended in a step 10.12. Otherwise the method jumps back to step 10.2.

The exchange of the second cryptography data can also ensue even if such an exchange has not been requested by the data center 3, but rather only other services should have been requested from the second data center 4 with the communication. It is possible to also centrally control the exchange of the second cryptography data via the second data center 4 and without cooperation of the first data center 3.

As is to be learned from FIG. 5, no temporal overlapping of the usage of two successive generations k and k+1 of the second cryptography data K2ₖ of the first data center 3 ensues in the present example. The second generation of the second cryptography data K2₂ is thus loaded after fulfillment of the second exchange criterion EC2₁ of the first generation of the second cryptography data K2₁ at a load point in time T_{L2-2}. The usage of the first generation of the second cryptography data K2₂ does not end yet at this point in time T_{L2-2}. However, the usage of the second generation of the second cryptography data K2₂ begins at the same time. In the present example, the beginning of its validity period T_{VS2-2} essentially coincides with its load point in time T_{L2-2} in order to enable an immediate usage. In other variants of the invention, the beginning of the validity period T_{VS2-k} can also be after the load point in time T_{L2-k}. The beginning of the validity period T_{VS2-k} can be defined by the fulfillment of any other second validity criterion.

The fulfillment of the second validity criterion, thus the beginning of the validity period T_{VS2-2} of the second cryptography data K2₂, furthermore represents a temporal event which, in the present example, causes the specification of a first exchange criterion EC1ᵢ₋ⱼ for all franking machines FMᵢ. It must thus be ensured that a cryptographic link furthermore exists between the new second cryptography data K2ₖ of the first data center 3 and the first cryptography data K1ᵢ₋ⱼ of the franking machine FMᵢ. In order to achieve this, the exchange of the second cryptography data K2ₖ of the first data center 3 requires an exchange of the first cryptography data K1ᵢ₋ⱼ of all franking machines FMᵢ. The beginning of the validity period T_{VS2-2} thus represents the point in time T_{EC1i-j} of the fulfillment of the first exchange criterion EC1ᵢ₋₂ of the second generation of the first cryptography data K1ᵢ₋₂ for all franking machines FMᵢ.

As mentioned, the load point in time T_{L2-k} lies after the point in time T_{EC2-1} of the fulfillment of the second exchange criterion EC2₁. This occurs by the second exchange criterion EC2₁ being a temporal criterion that defines the point in time T_{EC2-1}. However, the communication with the first data center 3 (in the framework of which the exchange and therewith the loading is initiated) ensues only after the point in time T_{EC2-1} of the fulfillment of the second exchange criterion EC2₁ of the first generation, such that the load point in time T_{L2-k} is later than the point in time T_{EC2-1}.

As also can be seen from FIG. 5, the second generation of the second cryptography data K2₂ is exchanged in an analogous manner. For this purpose, new second cryptography data K2₃ of the third generation are initially loaded into the second memory 3.4 at a load point in time T_{L2-3}. At an end of the validity period T_{VE2-2} of the second generation of the second cryptography data K2₂, the second cryptography data K2₂ are deleted from the second memory 3.4 and only the second cryptography data K2₃ of the third generation are still used, whereupon the exchange of the second cryptography data K2₂ of the second generation is concluded.

As is indicated in FIG. 5, the exchange of the second cryptography data K2ₖ of further generations continues. It is understood that second exchange criteria of any type can be used. In other variants of the invention, the second exchange criterion EC2ₖ can in turn also be a usage-dependent criterion as has been described above in connection with the first exchange criterion EC1ᵢ₋ⱼ.

In all cases, the second exchange criterion EC2ₖ preferably is selected so that the load point in time T_{L2-(k+1)} of the subsequent generation is, in the normal case, before the end of the validity period T_{VE2k} of the current generation k of the second cryptography data K2ₖ in order to ensure that no usage gaps of the first data center occur for lack of valid second cryptography data.

In this context it is understood that the second expiration criterion EC2ₖ can be mutually provided for a number of first data centers in a manner analogous to that for the first exchange criterion EC1ᵢ₋ⱼ.

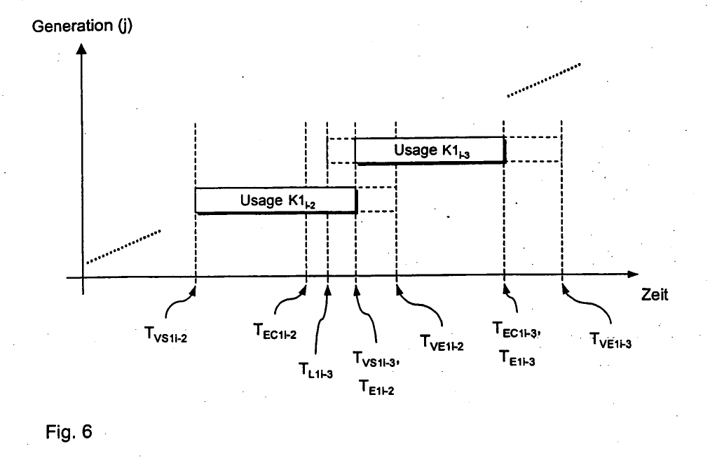

FIG. 6 shows a temporal usage diagram of the individual generations of the first cryptography data of a further preferred variant of the arrangement from FIG. 1. This variant does not fundamentally differ in design and functionality from those from FIG. 1, such that only the differences need be discussed.

As can be seen from FIG. 6, the third generation of the first cryptography data K1ᵢ₋₃ is loaded into the first storage 2.33 at a load point in time T_{L1i-3}. This loading point in time T_{L1i-3} lies before the beginning of the validity period T_{VS1i-3} of this first cryptography data K1ᵢ₋₃ of the third generation. This beginning of the validity period T_{VS1i-3} is provided to the new first cryptography data K1ᵢ₋₃ of the third generation by the first data center 3 as a new first validity criterion and is stored with the first cryptography data K1ᵢ₋₃ in the first memory 2.33.

Only with the fulfillment of the new first validity criterion are the first cryptography data K1ᵢ₋₂ of the second generation exchanged with the new first cryptography data K1ᵢ₋₃ of the third generation at the exchange point in time T_{E1i-2} that corresponds to the beginning of the validity period T_{VS1i-3}. Until this point in time, the first cryptography data K1ᵢ₋₂ of the second generation and the first cryptography data K1ᵢ₋₃ of the third generation are stored in parallel in the first memory 2.33.

The exchange point in time T_{E1i-2} of the first cryptography data K1ᵢ₋₂ of the second generation here also is before the end of the validity period T_{VE1i-2} of this first cryptography data K1ᵢ₋₂ of the second generation, consequently before the fulfillment of the first expiration criterion of the first cryptography data K1ᵢ₋₂ of the second generation. It is thus ensured that no usage gaps of the appertaining franking machine FMᵢ occur.

The present invention has been primarily described above using examples in which the respective cryptography data were formed as cryptographic keys. It is understood that the respective cryptography data can be other types of data, such as one or more cryptographic certificates.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for exchanging cryptography data comprising the steps of:
electronically storing cryptography data in a memory at a first data processing device;
establishing a communication between said first data processing device and a second data processing device located remote from said first data processing device and determining, in said second data processing device, whether an exchange criterion associated with at least one of said cryptography data and said first data processing device is fulfilled;
if said exchange criterion is fulfilled, initiating, in said second data processing device, an exchange step; and
in said exchange step, exchanging said cryptography data stored in said memory of said first data processing device with new cryptography data.

2. A method as claimed in claim 1 comprising predetermining said exchange criterion in said second data processing device.

3. A method as claimed in claim 1 wherein said cryptography data stored in said memory at said first data processing device have an expiration criterion associated therewith, and comprising selecting said exchange criterion so that fulfillment of said exchange criterion occurs before said expiration criterion.

4. A method as claimed in claim 3 comprising employing a temporal criterion as at least one of said expiration criterion and said exchange criterion.

5. A method as claimed in claim 3 comprising employing a non-temporal criterion as at least one of said expiration criterion and said exchange criterion, and selecting said non-temporal criterion from the group consisting of a criterion dependent on usage of said first data processing device and a criterion dependent on usage of said cryptography data stored in said memory at said first data processing device.

6. A method as claimed in claim 3 comprising:
associating a validity criterion with said new cryptography data, fulfillment of said validity criterion defining a beginning of a validity period of said new cryptography data; and
selecting said validity criterion to be fulfilled no later than fulfillment of said expiration criterion.

7. A method as claimed in claim 6 wherein said cryptography data stored in said memory of said first data processor comprise current cryptography data, and comprising the step of simultaneously storing said new cryptography data and said current cryptography data in said memory at said first data processor at least until fulfillment of said expiration criterion.

8. A method as claimed in claim 1 comprising modifying said exchange criterion upon conclusion of said exchange step.

9. A method as claimed in claim 1 wherein said memory at said first data processing device is a first memory, wherein the cryptography data stored in said first memory are first cryptography data, wherein said exchange criterion is a first exchange criterion, and wherein said exchange step is a first exchange step, and comprising the steps of:
storing second cryptography data in a second memory at said second data processing device;
associating a second exchange criterion with at least one of said second cryptography data and said second data processing device; and
in a second exchange step occurring no later than fulfillment of said second exchange criterion, exchanging said second cryptography data stored in said second memory for new second cryptography data.

10. A method as claimed in claim 9 comprising:
in said second exchange step, establishing a communication between said second data processing device and a third data processing device remote from said second data processing device and remote from said first data processing device;
monitoring fulfillment of said second exchange criterion at said third data processing device; and
at said third data processing device, initiating said second exchange step upon fulfillment of said second exchange criterion.

11. A method as claimed in claim 10 comprising predetermining said second exchange criterion at said third data processing device.

12. A method as claimed in claim 9 wherein said first cryptography data stored in said first memory of said first data processing device have an expiration criterion associated therewith, and comprising selecting said second exchange criterion so that fulfillment of said second exchange criterion occurs before said expiration criterion.

13. A method as claimed in claim 12 comprising employing a temporal criterion as at least one of said expiration criterion and said second exchange criterion.

14. A method as claimed in claim 12 comprising employing a non-temporal criterion as at least one of said expiration criterion and said second exchange criterion, and selecting said non-temporal criterion from the group consisting of a criterion dependent on usage of said second data processing device and a criterion dependent on usage of said second cryptography data stored in said second memory at said second data processing device.

15. A method as claimed in claim 12 comprising:
associating a validity criterion with said new second cryptography data, fulfillment of said validity criterion defining a beginning of a validity period of said new second cryptography data.

16. A method as claimed in claim 15 comprising:
selecting said validity criterion to be fulfilled no later than fulfillment of said expiration criterion.

17. A method as claimed in claim 15 wherein said cryptography data stored in said second memory of said second data processor comprise current second cryptography data, and comprising the step of simultaneously storing said new second cryptography data and said current second cryptography data in said second memory of said second data processor at least until fulfillment of said expiration criterion.

18. A method as claimed in claim 15 comprising selecting said first exchange criterion dependent on said new second validity criterion.

19. A method as claimed in claim 18 comprising selecting said first exchange criterion to be identical to said new second validity criterion.

20. A method as claimed in claim 18 comprising associating a validity point in time with said new second cryptography data, and setting said new second validity criterion to be reaching said validity point in time.

21. A method as claimed in claim 1 comprising:
providing a plurality of further first data processing devices respectively corresponding to said first data processing device and each able to establish a communication with said second data processing device; and
predetermining a common exchange criterion for said plurality of further first data processing devices.

22. A method for exchanging cryptography data comprising the steps of:
electronically storing cryptography data in a memory at a first data processing device;
establishing a communication between said first data processing device and a second data processing device located remote from said first data processing device and determining, in said second data processing device, whether an exchange criterion associated with at least one of said cryptography data and said first data processing device is fulfilled;
if said exchange criterion is fulfilled, initiating, in said second data processing device, an exchange step;
in said exchange step, exchanging said cryptography data stored in said memory of said first data processing device with new cryptography data; and
generating said new cryptography data dependent on fulfillment of at least one new cryptography data generation criterion.

23. A system for exchanging cryptography data comprising:
a first data processing device;
a memory at said first data processing device containing cryptography data;
a second data processing device remote from said first data processing device;
a communication arrangement allowing communication between said first data processing device and said second data processing device; and
said second data processing device comprising a processor that, at least upon establishment of a communication from said first data processing device to said second data processing device, monitors an exchange criterion associated with at least one of said cryptography data and said first data processing device, and that initiates an exchange of said cryptography data in said memory for new cryptography data upon fulfillment of said exchange criterion.

24. A system as claimed in claim 23 wherein said processor predetermines said exchange criterion in said second data processing device.

25. A system as claimed in claim 23 wherein said cryptography data stored in said memory at said first data processing device have an expiration criterion associated therewith, and wherein said processor selects said exchange criterion so that fulfillment of said exchange criterion occurs before said expiration criterion.

26. A system as claimed in claim 23 wherein said expiration criterion is a temporal criterion and wherein said processor sets said expiration criterion as a temporal criterion.

27. A system as claimed in claim 23 wherein said expiration criterion is a non-temporal criterion wherein said processor sets said exchange criterion as a non-temporal criterion, and selects the non-temporal exchange criterion from the group consisting of a criterion dependent on usage of said first data processing device and a criterion dependent on usage of said cryptography data stored in said memory of said first data processing device.

28. A system as claimed in claim 23 wherein said processor associates a validity criterion with said new cryptography data, fulfillment of said validity criterion defining a beginning of a validity period of said new cryptography data, and selects said validity criterion to be fulfilled no later than fulfillment of said expiration criterion.

29. A system as claimed in claim 28 wherein said cryptography data stored in said memory of said first data processor comprise current cryptography data, and wherein said processor causes said new cryptography data and said current cryptography data to be stored simultaneously in said memory of said first data processor at least until fulfillment of said expiration criterion.

30. A system as claimed in claim 23 wherein said processor modifies said exchange criterion upon conclusion of said exchange step.

31. A system as claimed in claim 23 wherein said memory at said first data processing device is a first memory, wherein the cryptography data stored in said first memory are first cryptography data, wherein said exchange criterion is a first exchange criterion, and wherein said exchange step is a first exchange step, and comprising:
a second memory at said second data processing device in which second cryptography data are stored;
a third data processing device remote from said second data processing device and remote from said first processing device;
a further communication arrangement allowing communication between said second data processing device and said third data processing device;
said third data processing device comprising a further processor, that at least upon establishment of a communication between said second data processing device and said third data processing device remote from said second data processing device;
monitors fulfillment of a second exchange criterion associating a second exchange criterion with at least one of said second cryptography data and said second data processing device; and at said third data processing device, and
initiates a second exchange step no later than fulfillment of said second exchange criterion to exchange said second cryptography data stored in said second memory for new second cryptography data.

32. A system as claimed in claim 31 wherein said further processor predetermines said second exchange criterion at said third data processing device.

33. A system as claimed in claim 31 wherein said first cryptography data stored in said first memory at said first data processing device have an expiration criterion associated therewith, and wherein said further processor selects said second exchange criterion so that fulfillment of said second exchange criterion occurs before said expiration criterion.

34. A system as claimed in claim 33 wherein said expiration criterion is a temporal criterion and wherein said further processor sets said second exchange criterion as a temporal criterion.

35. A system as claimed in claim 33 wherein said expiration criterion is a non-temporal criterion and wherein said further processor sets said second exchange criterion as a non-temporal, and selects the non-temporal exchange criterion from the group consisting of a criterion dependent on usage of said second data processing device and a criterion dependent on usage of said second cryptography data stored in said second memory at said second data processing device.

36. A system as claimed in claim 31 wherein said further processor associates a validity criterion with said new second cryptography data, fulfillment of said validity criterion defining a beginning of a validity period of said new second cryptography data.

37. A system as claimed in claim 36 wherein said further processor selects said validity criterion to be fulfilled no later than fulfillment of said expiration criterion.

38. A system as claimed in claim 37 wherein said cryptography data stored in said second memory at said second data processor comprise previous second cryptography data, and wherein said further processor causes said new second cryptography data and said previous second cryptography data to be stored simultaneously in said second memory at said second data processor at least until fulfillment of said expiration criterion.

39. A system as claimed in claim 37 wherein said further processor communicates said new second validity criterion to said processor, and wherein said processor selects said first exchange criterion dependent on said new second validity criterion.

40. A system as claimed in claim 39 wherein said processor selects said first exchange criterion to be identical to said new second validity criterion.

41. A system as claimed in claim 37 wherein said further processor associates a validity point in time with said new second cryptography data, and sets said new second validity criterion to be reaching said validity point in time.

42. A system as claimed in claim 23 comprising:
a plurality of further first data processing devices respectively corresponding to said first data processing device and each able to establish a communication with said second data processing device; and
said processor predetermining a common exchange criterion for said plurality of further first data processing devices.

43. A system as claimed in claim 23 wherein said first data processing device is a franking machine and said second data processing device is a data center.

44. A system for exchanging cryptography data comprising:
a first data processing device;
a memory at said first data processing device containing cryptography data;
a second data processing device remote from said first data processing device;
a communication arrangement allowing communication between said first data processing device and said second data processing device;
said second data processing device comprising a processor that, at least upon establishment of a communication from said first data processing device to said second data processing device, monitors an exchange criterion associated with at least one of said cryptography data and said first data processing device, and that initiates an exchange of said cryptography data in said memory for new cryptography data upon fulfillment of said exchange criterion; and
a further processor in said first data processing device that generates said new cryptography data upon fulfillment of at least one new cryptography data generation criterion.

45. A system for exchanging cryptography data comprising:
a first data processing device;
a memory at said first data processing device containing cryptography data;
a second data processing device remote from said first data processing device;
a communication arrangement allowing communication between said first data processing device and said second data processing device;
said second data processing device comprising a processor that, at least upon establishment of a communication from said first data processing device to said second data processing device, monitors an exchange criterion associated with at least one of said cryptography data and said first data processing device, and that initiates an exchange of said cryptography data in said memory for new cryptography data upon fulfillment of said exchange criterion; and
said processor generating said new cryptography data dependent on fulfillment of at least one new cryptography data generation criterion.
